(19) United States
(12) Patent Application Publication
(10) Pub. No.: US 2025/0199487 A1
(43) Pub. Date: Jun. 19, 2025

(54) CONTROL OF BUILDING SERVICES SYSTEMS

(71) Applicant: WAGO Verwaltungsgesellschaft mbH, Minden (DE)

(72) Inventors: Jan JENKE, Porta Westfalica (DE); Meike SCHARFF, Minden (DE); Stefan VAN LIER, Minden (DE); Nikolai FALKE, Porta Westfalica (DE); Michael STANGE, Sondershausen (DE); Benjamin NIEDERDEPPE, Leopoldshoehe (DE)

(73) Assignee: WAGO Verwaltungsgesellschaft mbH, Minden (DE)

(21) Appl. No.: 19/067,181

(22) Filed: Feb. 28, 2025

Related U.S. Application Data
(63) Continuation of application No. PCT/EP2023/072758, filed on Aug. 18, 2023.

(30) Foreign Application Priority Data
Aug. 31, 2022 (DE) 10 2022 122 039.7

(51) Int. Cl. G05B 13/02

(52) U.S. Cl. CPC G05B 13/0265

(57) ABSTRACT

A computer-implemented method for determining a parameterization of a building technology system. An ambient condition state is received that is detected by at least one sensor device. A number of ambient condition states stored in a database which satisfy a similarity criterion with regard to the detected ambient condition state is determined. If the number is less than a predetermined threshold, the parameterization is determined of the building technology system based on at least one predefined parameterization rule, or if the number is greater than or equal to the predetermined threshold, the parameterization is determined of the building technology system based on a machine learning model.

This nonprovisional application is a continuation of International Application No. PCT/EP2023/072758, which was filed on Aug. 18, 2023, and which claims priority to German Patent Application No. 10 2022 122 039.7, which was filed in Germany on Aug. 31, 2022, and which are both herein incorporated by reference.

### BACKGROUND OF THE INVENTION

### Field of the Invention

The present invention relates generally to the technical field of building technology systems and, in particular, to the control of building technology systems which may comprise, for example, sun protection systems and/or lighting systems.

### Description of the Background Art

Building technology systems comprise all permanently installed technical systems inside and outside buildings that serve the functional use of buildings. Such systems are, for example, necessary for the functioning of the building or increase user comfort and/or safety. For example, building technology systems include sun protection systems, lighting systems, fire alarm systems, burglar alarm systems, photovoltaic systems, or access control systems. Building technology systems are sometimes also referred to as home automation systems, technical building equipment or supply technology.

The installation of building technology systems in buildings is typically carried out by qualified technical personnel. In addition to the actual system, control elements are provided so that a user can choose his/her own settings, i.e., he/she can adapt the parameterization of the respective building technology system to his/her preferences, in particular to his/her situation-related preferences or to his/her preferences determined by ambient conditions.

Furthermore, rule-based control units are often part of building technology systems and determine the parameterization of the respective building technology system based on, for example, predefined rules and measured values from sensor devices. The sensor devices are to measure ambient conditions and may include, for example, light sensors or temperature sensors. Depending on the configuration, a user may be given the opportunity to change the rules and adapt them to his/her preferences. The purpose of such rule-based control units is to increase user comfort and reduce the need for operating the control elements.

However, setting the rules is a challenge for many users. Defining rules or changing preset rules so that the rules adequately reflect a user's preferences requires knowledge of the user's preferences, for example a certain room temperature or a certain lighting intensity. Furthermore, a correct translation of these user preferences into a rule is required. This translation is regularly done by the user himself/herself without assistance. Often, a room is also used by different people who may have different preferences. Overall, in practice, when using building technology systems, it thus often happens that control elements have to be operated manually in order to meet the preferences of the users. In other words, the ability to set rules or change preset rules only slightly reduces the need for manual operation of control elements.

### SUMMARY OF THE INVENTION

It is therefore an object of the present invention to provide a method which increases the user comfort of building technology systems and thus at least partially overcomes the above-mentioned disadvantages of the prior art.

According to an example of the invention, a computer-implemented method is provided for determining a parameterization of a building technology system. The method may comprise receiving an ambient condition state detected by at least one sensor device. The method may comprise determining a number of ambient condition states stored in a database which satisfy a similarity criterion with respect to the detected ambient condition state. If the number is smaller than a predetermined threshold, the method may comprise determining the parameterization of the building technology system based on at least one predefined parameterization rule or, if the number is greater than or equal to the threshold, determining the parameterization of the building technology system based on a machine learning model.

A building technology system may be a permanently installed, or mobile, technical system inside or outside a building that serves the functional use of buildings. Examples of building technology systems include, in particular, sun protection systems, air conditioning systems, heating systems, lighting systems, fire alarm systems, burglar alarm systems, photovoltaic systems, access control systems, or systems that combine several of the above functions in one system. Preferably, the computer-implemented method is provided for determining a parameterization of a building technology system which is configured as a sun protection and lighting system.

An ambient condition state may relate to one or more measurement points in time at which the state of an environment of a building technology system, for example the temperature, the lighting conditions, or the wind strength and/or wind direction, are measured. The ambient condition state may further comprise generally available information about the state of the environment of the building technology system, for example a time or a date. Furthermore, the ambient condition state may include a current parameterization or setting of a respective building technology system. In this respect, an ambient condition state is to be understood as one or more user-perceivable or user-verifiable ambient conditions.

The at least one sensor device may be configured to detect an ambient condition state in the form of measurement data and may, in particular, have a plurality of sensors, for example a first temperature sensor for the temperature outside the building, a second temperature sensor for the temperature inside the building, a light sensor and/or a wind sensor. In particular, scaling of the ambient condition and/or the parameterization may be required. Preferably, the measurement data acquired by means of the at least one sensor device are being scaled. The scaling of an ambient condition state and/or a parameterization may be in a value range between 0 and 1, for example if the ambient condition state and/or the parameterization is or are available as a vector.

For example, an ambient condition state x_1 may contain five pieces of information x_1_1, x_1_2, x_1_3, x_1_4, x_1_5 about the environment and be in the form of a vector of measured values. The values x_1_1, x_1_2, x_1_3, x_1_4, x_1_5 may preferably be fully or partially scaled or scaled after the measurement or recording, in particular to a value range between 0 and 1. The value x_1_1 may, for example, be a scaled measurement value of a light sensor. The value x_1_2 may, for example, be a scaled measurement value of a temperature sensor. The value x_1_3 may, for example, be a scaled measurement value of a wind sensor. The value x_1_4 may, for example, be a non-scaled measurement value of a room occupancy sensor that records information about the number of people in a particular room. The value x_1_5 may, for example, be a non-scaled time.

A distinction may be made between detected ambient condition states and stored ambient condition states. A detected ambient condition state may be an ambient condition state at a current point in time, in particular during the runtime of the method. A stored ambient condition state may be an ambient condition state stored in a database, which may, for example, have existed at an earlier point in time or may have been specified for putting the building technology system into operation. The database may thus store ambient conditions recorded at an earlier point in time or made available in advance. In particular, stored ambient condition states may be put in the database in pairs with the associated parameterizations of the building technology system. A parameterization of an ambient condition may include the setting of a sun protection system and the setting of lighting in the room.

In the method step of determining a number of ambient condition states stored in a database which satisfy a similarity criterion with regard to the detected ambient condition state, the difference and/or similarity between the detected ambient condition state and the stored ambient condition states may be evaluated. If the ambient condition states are present as vectors as described above, this evaluation may be carried out in the form of a vectorial distance calculation, wherein the absolute value of the vectors may be compared, in particular by forming a difference between the absolute values of the vectors. Alternatively or additionally, other distance calculation methods commonly used in vector calculus may be used, in particular the Euclidean distance calculation. Alternatively, the differences between the individual values of the vectors may be calculated by subtracting the vectors and used. For each pair of ambient condition states for which the calculation is performed, a similarity criterion may be evaluated. Depending on the type of distance calculation method, a different similarity criterion may be used. Furthermore, both the distance calculation method and the similarity criterion may be varied depending on the type of building technology system to be controlled. In particular, several distance calculation methods and/or similarity criteria may be provided from which to choose.

An example of a similarity criterion is, in the case of the Euclidean distance of the ambient condition states, that the Euclidean distance is below a certain threshold. The number of stored ambient condition states for which the similarity criterion is met may be determined by simple counting.

If the number is smaller than a predetermined threshold, the parameterization of the building technology system may be determined based on at least one predefined parameterization rule. This advantageously ensures that if there is no or an insufficient data base in the form of stored ambient condition states, the parameterization or setting of the building technology system can be adjusted. For example, if a sun protection system on the window of a building has only recently been put into operation, the database contains only a small number of previously stored ambient condition states. If the sun protection system is parameterized or adjusted in such a way that it is completely or almost completely retracted, sunlight can enter the room unhindered. At a time of day with high levels of sunlight, it is usually desired that the sun protection system offers a certain degree of shielding of the room from sunlight. Based on a predefined parameterization rule that reflects this, the sun protection system is at least partially extended if a light sensor detects high levels of sunlight.

If the number is greater than or equal to the threshold, the determination of the parameterization of the building technology system may be based on a machine learning model. The machine learning model is able to learn the preferences of one or more users, so that the parameterization of the building technology system based on the machine learning model is closer to the actual preferences of the one or more users, provided there is a sufficient data base. As explained above, a sufficient data base is available if the number of stored ambient condition states that satisfy the similarity criterion with respect to the detected ambient condition state is above a threshold. It should be mentioned at this point that the stored ambient condition states and the corresponding stored parameterizations can be stored in the database as pairs. In other words, the machine learning model can be used whenever there is already sufficient empirical data about the user's preferences. The empirical data may be recorded after putting the system in use over a longer period of use. For example, each time the user manually changes, using control elements, the parameterization or setting of the building technology setting, these changes can be saved in such a way that the current ambient condition state and the manual parameterization are stored as a pair in the database.

The machine learning model may thus replace the predefined parameterization rules after some time. Because the predefined parameterization rules may, in particular, comprise rules that are based, for example, on the preferences of the average population, these parameterization rules may not adequately reflect the preferences of the specific user or users of the building technology system. However, the machine learning model is able to represent these preferences with a relatively high degree of precision once there are enough stored ambient condition states in the database to draw on. In other words: If an ambient condition state is detected for which there are too few similar stored ambient condition states (and associated parameterizations), the functionality of the building technology system is ensured by applying predefined parameterization rules. This provides a minimum level of user comfort even immediately after putting a newly installed building technology system to use, meaning that the user does not have to make every setting manually using control elements each time. However, as soon as there are enough stored ambient condition states (and associated parameterizations) for a detected ambient condition state that are sufficiently similar to the detected ambient condition state, the machine learning model will determine the parameterization or setting of the building technology system and advantageously carry out a parameterization that is close to the user's preferences.

The proposed functionality becomes clearer when considering the service life of the building technology system, starting with the initial installation. At the beginning, there are no stored ambient condition states (and associated parameterizations), but only predefined parameterization rules, which may, for example, be provided by the manufacturer of the building technology system and may be oriented towards a hypothetical average user. During operation, ambient condition states are recorded continuously or at discrete intervals by a sensor device and the predefined parameterization rules are drawn upon. This may be regarded as a first phase of the service life of the building technology system. After some time, the user, who is, for example, a resident of the building in which the building technology system is used, has made manual settings using control elements or, if the parameterizations based on the predefined parameterization rules match with his/her preferences, has omitted the manual setting. By making manual settings and omitting manual settings, for example for a specified period of time, stored ambient condition states (and associated parameter parameterizations) are stored in the database. If ambient condition states are detected frequently, they can be assessed based on the machine learning model. In the case of rarely occurring ambient condition states, it is still possible to resort to the predefined parameterization rules. In this phase, which can be considered as the second phase of the service life of the building technology system, both the machine learning model and the predefined parameterization rules are required and used. After some time has passed and the machine learning model can access a sufficient number of stored ambient condition states (and associated parameterizations), the machine learning model is primarily used; ideally only the machine learning model is used. This may be regarded as the third phase of the service life of the building technology system. Should the user change, for example due to a change of the tenant of a building, the machine learning model is able to gradually adapt to the new preferences in the manner described above. Preferably, a reset function of the database of stored ambient condition states (and associated parameterizations) may be provided.

The determination of the parameterization may be effectuated, in particular, by a control unit of the building technology system. The control unit may, for example, be a central control unit with a calculation unit and a measurement data reception interface via which measurement data from the at least one sensor device are received. Alternatively or additionally, the determination of the parameterization may be supported by a server, wherein, in particular, the database can be stored on the server. Advantageously, the calculations may be carried out at least partially on the server, for example the determination of the number of stored ambient condition states that meet the similarity criterion and/or the determination of the parameterization based on predefined parameterization rules and/or the determination of the parameterization based on the machine learning model. Preferably, all calculation steps may be carried out by a server. If a server is used, the building technology system is communicatively connected to the server, in particular via a data network.

The training of the machine learning model may, as explained in the example above, be carried out as follows:

In response to a manual parameterization of a building technology system or a failure to parameterize for a predefined period of time, an ambient condition state and an associated parameterization of the building technology system may be stored in a database, and the training of the machine learning model may be carried out using at least a portion of the ambient condition states and associated parameterizations in the database.

Training the machine learning model may further include training/test and/or cross validation splitting of the database. Training/test and cross validation splitting are well-known methods from the field of machine learning that can counteract the so-called problems of overfitting and underfitting of a machine learning model. The goal is to find an optimum for the machine learning model that, if possible, does not involve overfitting or underfitting. A machine learning model is overfitted if the model relies too heavily on existing training data, making it difficult to classify new observations. A machine learning model that is overfitted relies primarily on stored data and reacts with a higher error rate to new observations. In the field of machine learning, this is referred to as unnecessary consideration of noise. Underfitting occurs when stored data is not sufficiently taken into account. This can also lead to an increased error rate of the machine learning model.

Preferably, the method further comprises: sending a command to transition from a current parameterization of the building technology system to the determined parameterization, wherein preferably the sending only takes place if the determined parameterization deviates from the current parameterization by a predefined parameterization threshold.

Sending a command to change the parameterization to the determined parameterization may be carried out, in particular, by a control unit of the building technology system. For example, based on the determined parameterization, a command may be sent to retract or extend a sun protection system. By providing a parameterization threshold, it is ensured that minor deviations between the determined parameterization and the current parameterization are ignored. This is particularly advantageous with regard to the energy requirements of the building technology system, as unnecessary changes are avoided. The parameterization threshold also increases user comfort, as the user is not disturbed by any noise, for example when a sun protection system is extended or retracted, if this is not necessary. In this respect, having the parameterization threshold resolves, in a simple manner, a conflict of objectives, for example in the case of a sun protection system between an optimal lighting condition and the lowest possible background noise, which enables focused work.

It may also be provided that predefined restrictions, in particular safety restrictions, are (always) observed when determining the parameterization.

Within the framework of legal requirements, which may include fire protection regulations, for example, it is often not possible to create optimal conditions from the user's point of view. In other words, the optimum is limited by legal requirements. Furthermore, a user may also wish for a certain level of protection against break-ins as part of his/her security needs, although this need may only be met with a non-optimal parameterization of a building technology system. By providing predefined restrictions, such legal requirements or other mandatory preferences are always taken into account when determining the parameterization, regardless of whether the parameterization is determined using the predefined parameterization rules or using the machine learning model.

Preferably, the method further comprises: receiving presence information and/or identification information, wherein the presence information contains at least information about the number of people in a room which is covered by the building technology system, wherein the identification information contains at least information that enables a clear identification of people in the room or people entering the room, and wherein the presence information and/or the identification information are taken into account for determining the parameterization.

Furthermore, the at least one predefined parameterization rule and/or the machine learning model for determining the parameterization may be selected from a plurality of parameterization rules and a plurality of machine learning models, respectively, depending on the presence information and/or depending on the identification information.

Presence information includes information about how many people are present in a room or building who can perceive the parameterization of the building's technical system. This presence information may be recorded, for example, using an access sensor at an access point, such as a door. Such an access sensor may be part of the sensor device. The presence information may be part of a detected ambient condition state and/or stored ambient condition state.

Identification information includes information that enables the unambiguous identification of persons present in a room or building. In this context, an unambiguous identification does not have to include any personal data that could be used to identify the person (name, appearance, etc.). The unambiguous identification of a person only requires differentiation from other persons and can also be based on a unique number (unique identifier, UID) of an access authorization medium, for example an access card. The identification information may, for example, be recorded by an access control device at an access point, such as a door. Such an access control device may be part of the sensor device. The identification information may be part of a detected ambient condition state and/or stored ambient condition state.

Taking presence information into account is advantageously made possible by a precise adaptation to the occupancy status of a room or a building. For example, if there are a large number of people in a room, the air conditioning system of the room may be parameterized in such a way that increased dehumidification takes place before an increased air humidity is measured by a humidity sensor. This enables predictive determining of a parameterization.

Taking identification information into account also makes it possible to take individual preferences of different users into account. In particular, in the case of so-called “shared offices” (shared workplaces), a situation with different users is conceivable. For this purpose, different predefined parameterization rules and/or machine learning models may be provided for different persons. If there are several people with different preferences in a room or building, it may be preferable to choose a rule or machine learning model to determine the parameterization that meets as many of the different preferences as possible. Preferably, a temporary rule or a temporary machine learning model may be formed in this case, based on which the parameterization is determined. The temporary rule or machine learning model may represent an optimal average of the preferences of the different people in the room or building.

Preferably, the ambient condition state detected by the sensor device comprises at least one of the following pieces of information: a measured value of a light sensor, a measured value of a wind sensor, a measured value of a temperature sensor, a difference between a temperature and a perceived temperature, a measured value of a room occupancy sensor, a time, a measured value of a touch sensor, preferably on a window handle, a date, preferably without the year, a status of a building element, preferably a window, a status of an air conditioning system, a status of a heating system, a status of a sun protection system, a status of a lighting system; and/or the parameterization of the building technology system comprises a parameterization of at least one of the following: a building element, preferably a window, an air conditioning system, a heating system, a sun protection system, and/or a lighting system.

The similarity criterion for stored ambient condition states may be evaluated according to the cell-lists algorithm, wherein the similarity criterion for a stored ambient condition state is preferably met if the difference between the detected ambient condition state and the stored ambient condition state does not exceed a value.

The cell-lists algorithm provides an effective method to evaluate the similarity criterion. In this way, the number of stored ambient condition states that are sufficiently similar to a detected ambient condition state can be easily determined.

According to the invention, a computer-implemented method for training a machine learning model is also provided. The machine learning model may be for use in a method described above. In response to a manual parameterization of a building technology system or non-parametrization persisting for a predefined period of time, the method may comprise saving an ambient condition state and an associated parameterization of the building technology system in a database. The method may comprise training the machine learning model using at least a subset of the ambient condition states and associated parameterizations in the database.

The method for training a machine learning model may, in particular, be for (self-learning) sun protection and lighting control by an appropriately designed building technology system. The method is explained below based on the example of a building technology system that is a sun protection system. With regard to the service life of the sun protection system, starting with the initial installation, there are no stored ambient condition states (and associated parameterizations) at the beginning, but only predefined parameterization rules, which may, for example, be provided by the manufacturer of the building technology system and may be oriented towards a hypothetical average user. During operation, ambient condition states are recorded continuously or at discrete intervals by a sensor device and the predefined parameterization rules are drawn upon. The resulting parameterization will correspond to the user's preferences in some cases but not in others.

If a parameterization corresponds to the user's preferences, the user will refrain from changing the parameterization via the control elements of the sun protection system. For example, to train the machine learning model, after a parameterization has been determined based on a predefined rule, the time during which the user does not make any changes using the control elements may be recorded. If the user does not make any changes for a certain period of time, it may be concluded that the parameterization corresponds to the user's actual preferences as regards the current ambient condition state. The detected ambient condition state and the associated parameterization are stored in the database as a stored ambient condition state and used as training data for the machine learning model.

However, if the parameterization does not correspond to the user's preferences, the user will manually change the parameterization using the control elements and, for example, further retract or extend the sun protection system. For example, to train the machine learning model, after manual parameterization by the user, it may be concluded that the new parameterization corresponds to the user's preferences as regards the current ambient condition state. The detected ambient condition state and the associated parameterization are stored in the database as a stored ambient condition state and used as training data for the machine learning model. Alternatively or additionally, after manual parameterization by the user, the time during which the user subsequently does not make any changes via the control elements may be recorded. If no further change is detected via the control elements within a predefined period of time after manual parameterization, it may be concluded that the parameterization now corresponds to the user's preferences for the current ambient condition state. The detected ambient condition state and the associated parameterization are stored in the database as a stored ambient condition state and used as training data for the machine learning model.

After some time, the user, who may be a resident of the building in which the sun protection system is installed, has generated sufficient training data so that the need for manual changes via the control elements occurs less and less frequently. Should the user change, for example due to a change of the tenant of a building, the machine learning model is able to gradually adapt to the new preferences in the manner described above.

Furthermore, a memory cleanup may be provided, wherein it is checked whether the number of stored ambient condition states exceeds a predetermined maximum number. The maximum number may, in particular, be a maximum permitted number of stored ambient condition states. Memory cleanup provides for balanced data quality and data quantity, which ensures the functionality of the machine learning model.

In particular, the cell-lists algorithm may be used for memory cleanup. In this case, the maximum number may be specified per cell in the cell-lists algorithm. This is particularly advantageous because the specification of maximum numbers per cell avoids data gaps in the sense of missing stored ambient condition states, for example for rarely occurring ambient condition states. In other words, it is ensured that a sufficient data base of stored ambient condition states is maintained over the entire definition range of detectable ambient condition states.

If the number of stored ambient condition states exceeds the maximum number or the maximum number within a cell of the cell-lists algorithm, the oldest stored ambient condition states may be deleted until the number of stored ambient condition states no longer exceeds the maximum number. This makes it easy to monitor the machine learning model.

Furthermore, when using the method for training the machine learning model in one of the methods described above for determining a parameterization of a building technology system, an operation of control elements of the building technology system by a user and/or an occupancy of the room and omission of operation of the control elements for a predefined period of time is detected and, in particular, the current ambient condition state (with associated parameterization) is stored in the database. Preferably, if another criterion is met, an ambient condition state (with associated parameterization) stored in the database receives a higher or lower weighting than other ambient condition states (with associated parameterization) stored in the database. For example, the other criterion which leads to a higher weighting of a stored ambient condition state (with associated parameterization) may be a failure to operate the control elements for another longer period of time.

Furthermore, the machine learning model may be trained by means of supervised and/or reinforcement machine learning.

In the context of supervised training of the machine learning model, the use of training/test and/or cross validation splitting of the stored ambient condition states (and associated parameterizations) may be envisaged (see explanations above). Additionally or alternatively, a nearest neighbor classification, preferably based on a cell-lists algorithm, may be provided. A nearest-neighbor classification is a parameter-free method commonly used in the field of density functions that enables a common class assignment of neighboring values, in this case ambient condition states. Preferably, neural networks and/or decision trees may be used. Compared to nearest-neighbor classifiers, these have the advantage of better detecting and ignoring irrelevant measurements.

The weighting may, in particular in the context of reinforcement machine learning, be carried out analogously to the principle of “reward and penalty”. Rewards may lead to a higher weighting of stored ambient condition states, whereas penalties may lead to a lower weighting of stored ambient condition states. In particular, it may be that only a higher weighting (reward) or only a lower weighting (penalty) is provided for. A reward and thus a higher weighting of an ambient condition state may be triggered, in particular, with an increase in time during which a user does not operate the control elements. The reward or higher weighting may, for example, increase continuously with the length of time the control elements are not operated. A penalty or lower weighting of ambient condition states may be triggered, in particular, if a user operates the control elements. The more often a user performs an operation, the higher the penalty or the lower the weighting may be due to the operation.

Reinforcement machine learning preferably includes criteria that link certain actions of a user, in particular operations of control elements, with a reward or higher weighting or with a penalty or lower weighting of an ambient condition state. In particular, the criteria can be further developed within the framework of a separate criteria learning model in order to optimize the conditions for and the level of changes in weightings. This makes it possible to take into account dead times that occur, for example, during heating and cooling. A dead time may occur, in particular, due to a difference between a perceived temperature and an actual temperature and may, for example, be the time that elapses until the perceived and actual temperatures merge.

Preferably, a reset function of the machine learning model is provided, wherein, in particular, the stored training data is deleted.

According to the invention, a device, in particular a building technology system, is provided which comprises computer components for carrying out one of the methods described above.

In particular, the device may comprise control elements. The control elements are preferably configured to detect subjective inputs of a user via, preferably, a single input value.

According to the invention, a computer program is provided, comprising instructions which, when the program is executed by a computer, cause the computer to carry out one of the methods described above.

The technical advantages and examples described with respect to the method according to the invention apply equally to the device according to the invention and to the computer program according to the invention.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a first schematic depiction of an example of the present invention; and

FIG. 2 shows a second schematic depiction of an example of the present invention.

### DETAILED DESCRIPTION

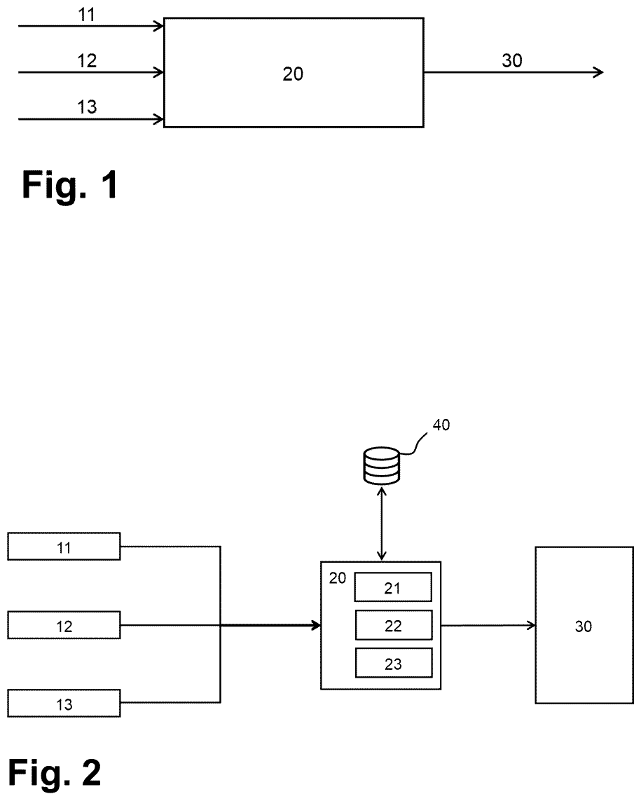

FIG. 1 is a highly simplified depiction of an example of the method according to the invention for controlling a building technology system. A building technology system may be a system that has the functions of sun protection systems, air conditioning systems, heating systems, lighting systems, fire alarm systems, burglar alarm systems, photovoltaic systems, and/or access control systems.

FIG. 1 shows a control unit 20 which is configured to perform the method. The control unit 20 may, for example, be a part of the building technology system or a remote control unit, with the building technology system being communicatively connected to the remote control unit. FIG. 2 includes a higher level of detail regarding the control unit 20.

Input values for the control system 20 are: ambient condition states detected by at least one sensor device 11, operations or omitted operations of the control elements 12, and currently available parameterizations 13 of the building technology system. It is understood that embodiments of the invention may also comprise only a subset of these input values. Based on these input values, the control unit 20 determines a new parameterization 30 of a building technology system.

The functionality of the control unit 20 is explained in more detail below with reference to FIG. 2. In this example, the control unit 20 comprises predefined parameterization rules 21, at least one machine learning model 22 and a database management system 23. Furthermore, the control unit 20 is communicatively connected to a database 40 and accesses it. The database 40 may be part of a remote server system. The data stored in the database 40 are managed by the database management 23.

The machine learning model 22 may comprise, or be, an artificial neural network (ANN), in particular making use of multilayer perceptrons (MLP). Alternatively or additionally, the use of decision trees and/or a random forest procedure is preferred. In general, the machine learning model 22 may be based on a machine learning algorithm. Machine learning can refer to algorithms and statistical models that computer systems may use to perform a specific task without using explicit instructions, rather relying on models and inference. For example, in machine learning, instead of a rule-based transformation of data, a transformation of data may be used that may be derived from an analysis of historical and/or training data. For example, the content of images may be analyzed using a machine learning model or using a machine learning algorithm. For the machine learning model to analyze the content of an image, the machine learning model may be trained using training images as input and training content information as output. By training the machine learning model with a large number of training images and/or training sequences (e.g., words or sentences) and associated training content information (e.g., labels or annotations), the machine learning model “learns” to recognize the content of the images, so that the content of images not included in the training data can be recognized using the machine learning model. The same principle may be used for other types of sensor data as well: by training a machine learning model using training sensor data and a desired output, the machine learning model “learns” a conversion between the sensor data and the output, which can be used to provide an output based on non-training sensor data provided to the machine learning model. The provided data (e.g., sensor data, metadata, and/or image data) can be preprocessed to obtain a feature vector, which is used as input for the machine learning model.

Machine learning models may be trained based on training input data. The examples above use a training procedure called supervised learning. With supervised learning, the machine learning model may be trained using a plurality of training samples, where each sample may comprise a plurality of input data values and a plurality of desired output values, i.e., each training sample may be associated with a desired output value. By specifying both, training samples and desired output values, the machine learning model “learns” which output value to output based on an input sample that is similar to the samples provided during training. In addition to supervised learning, semi-supervised learning may also be used. With semi-supervised learning, some of the training samples may lack a desired output value. Supervised learning may be based on a supervised learning algorithm (e.g., a classification algorithm, a regression algorithm, or a similarity learning algorithm). Classification algorithms may be used if the outputs are restricted to a limited set of values (categorical variables), i.e, the input may be classified as one of a limited set of values. Regression algorithms may be used if the outputs provide any numerical value (within a range). Similarity learning algorithms may be similar to both classification and regression algorithms but are based on learning from examples using a similarity function that measures how similar or related two objects are. Besides supervised learning or semi-supervised learning, unsupervised learning may be used to train the machine learning model. With unsupervised learning, (only) input data may be provided and an unsupervised learning algorithm may be used to find structure in the input data (e.g. by grouping or clustering the input data, finding commonalities in the data). Clustering is the assignment of input data comprising a plurality of input values to subsets (clusters) such that input values within the same cluster are similar according to one or more (predefined) similarity criteria, while they are dissimilar to input values contained in other clusters.

Reinforcement learning is a third group of machine learning algorithms. In other words, reinforcement learning may be used to train the machine learning model. With reinforcement learning, one or more software actors (so-called “software agents”) are trained to perform actions in an environment. Based on the actions taken, a reward is being calculated. Reinforcement learning is based on training one or more software agents to select the actions in such a way that the cumulative reward is increased, resulting in software agents that become better at the task with which they are charged (as evidenced by increasing rewards).

Furthermore, some techniques may be applied to some of the machine learning algorithms. For example, feature learning may be used. In other words, the machine learning model may be trained at least in part using feature learning, and/or the machine learning algorithm may include a feature learning component. Feature learning algorithms, called representation learning algorithms, may preserve the information in their input but transform it in a way that makes it useful, often as a preprocessing stage before performing classification or prediction. Feature learning may, for example, be based on principal component analysis or cluster analysis.

In some examples, anomaly detection (i.e., outlier detection) may be used, which aims to provide identification of input values that raise suspicion because they differ significantly from the majority of input and training data. In other words, the machine learning model may be trained at least in part based on anomaly detection, and/or the machine learning algorithm may include an anomaly detection component.

In some examples, the machine learning algorithm may use a decision tree as a prediction model. In other words, the machine learning model may be based on a decision tree. With a decision tree, the observations about an object (e.g., a set of input values) may be represented by the branches of the decision tree, and an output value corresponding to the object may be represented by the leaves of the decision tree. Decision trees may support both discrete values and continuous values as output values. If discrete values are used, the decision tree may be called a classification tree; if continuous values are used, the decision tree may be called a regression tree.

Association rules are another technique that may be used in machine learning algorithms. In other words, the machine learning model may be based on one or more association rules. Association rules may be created by identifying relationships between variables in large data sets. The machine learning algorithm may identify and/or use one or more relationship rules that represent the knowledge derived from the data. The rules may be used, for example, to store, manipulate, or apply the knowledge.

Machine learning algorithms are usually based on a machine learning model. In other words, the term “machine learning algorithm” may refer to a set of instructions that may be used to create, train, or use a machine learning model. The term “machine learning model” may refer to a data structure and/or a set of rules that represents the learned knowledge (e.g., based on the training performed by the machine learning algorithm). In examples, the use of a machine learning algorithm may imply the use of an underlying machine learning model (or a plurality of underlying machine learning models). The use of a machine learning model may imply that the machine learning model and/or the data structure/set of rules that constitutes the machine learning model is trained by a machine learning algorithm.

For example, the machine learning model may be an artificial neural network (ANN). ANNs are systems inspired by biological neural networks such as those found in a retina or brain. ANNs comprise a plurality of interconnected nodes and a plurality of connections, called edges, between the nodes. There are typically three types of nodes, input nodes that receive input values, hidden nodes that are (only) connected to other nodes, and output nodes that provide output values. Each node may represent an artificial neuron. Every edge may forward information from one node to another. The output of a node may be defined as a (nonlinear) function of its inputs (e.g., the sum of its inputs). The inputs of a node may be used in the function based on a “weight” of the edge or node providing the input. The weight of nodes and/or edges may be adjusted in the learning process. Training an artificial neural network may involve adjusting the weights of the nodes and/or edges of the artificial neural network, i.e., to achieve a desired output for a given input.

Alternatively, the machine learning model may be a support vector machine, a random forest model, or a gradient boosting model. Support vector machines (i.e., support vector networks) are supervised learning models with associated learning algorithms that may be used to analyze data (e.g., in a classification or regression analysis). Support vector machines may be trained by providing an input with a plurality of training input values belonging to one of two categories. The support vector machine may be trained to assign a new input value to one of the two categories. Alternatively, the machine learning model may be a Bayesian network, which is a probabilistic directed acyclic graphical model. A Bayesian network may represent a set of random variables and their conditional dependencies based on a directed acyclic graph. Alternatively or additionally, the machine learning model may be based on a genetic algorithm, which is a search algorithm and heuristic technique that mimics the process of natural selection.

Regardless of the implementation of the machine learning model, one aim of the example shown is to determine a new parameterization 30 of a building technology system that corresponds to the preferences or needs of users of a building which is equipped with the building technology system. For this purpose, a ambient condition state detected by at least one sensor device 11 is first received.

The term “ambient condition state” may refer to one or more measurement points in time at which the state of an environment of a building technology system, for example the temperature, the lighting conditions, or the wind strength and/or wind direction, are measured. The ambient condition state may further comprise generally available information about the state of the environment of the building technology system, for example a time or a date. Furthermore, the ambient condition state may include a current parameterization or setting of a respective building technology system. In this respect, an “ambient condition state” is to be understood as one or more user- perceivable or user-verifiable ambient conditions.

The at least one sensor device 11 is configured to detect an ambient condition state in the form of measurement data and may, in particular, comprise a plurality of sensors, for example a first temperature sensor for the temperature outside the building, a second temperature sensor for the temperature inside the building, a light sensor or a wind sensor.

The example shown in FIG. 2 comprises the control unit of a building technology system, in particular a sun protection and lighting system, wherein the computer-implemented method described above for determining a parameterization 30 is provided, which further comprises the method also described above for training the machine learning model 22.

In a first step, an ambient condition state detected by at least one sensor device 11 is received. The ambient condition state may be scaled, in particular in a value range between 0 and 1. Preferably, the detected ambient condition state is recorded as a vector or the measured values detected by means of the at least one sensor device 11 are converted into vector form, wherein, if scaling occurs, the scaling occurs for each value of the detected vector of the ambient condition state.

In a second step a number of ambient condition states stored in a database 40 which satisfy a similarity criterion with respect to the detected ambient condition state may be determined. The stored ambient condition states may also be scaled and may be available in the form of a vector. When determining a number of states of ambient conditions stored in the database which satisfy a similarity criterion with regard to the detected ambient condition state, the difference and/or similarity between the detected ambient condition state and the stored ambient condition states is being evaluated. This can be done in the manner described above based on using the cell-lists algorithm.

If the number is smaller than a predetermined threshold, for example 3, the parameterization 30 may be determined based on at least one predefined parameterization rule 21. This advantageously ensures that even if there is no or an insufficient data base in the form of stored ambient condition states, the parameterization or setting of the building technology system is adapted and a minimum level of user comfort is guaranteed even in this case. For example, the at least one predefined parameterization rule 21 may be based on a preference that can be attributed normally to an average user. Such a situation may be the case in this example: At a time of day with high levels of sunlight, it is usually desired that the sun protection system offers a certain degree of shielding of the room from sunlight. Based on a predefined parameterization rule 21 that reflects this, the sun protection system is at least partially extended if a light sensor detects high levels of sunlight.

If the number is greater than or equal to the threshold, the parameterization may be determined based on a machine learning model 22. The machine learning 22 model is able to learn the preferences of one or more users, so that the parameterization 30 of the building technology system based on the machine learning model 22 is closer to the actual preferences of the one or more users, provided there is a sufficient data base. As explained above, a sufficient data base is present if the number of stored ambient condition states that satisfy the similarity criterion with respect to the detected ambient condition state is above a threshold.

It should be mentioned at this point that the stored ambient condition states and the corresponding stored parameterizations can be stored in the database 40 as pairs. In other words, the machine learning model 22 can be used whenever there is already sufficient empirical data about the user's preferences. The empirical data may be recorded over a longer period of use after putting the system in use. For example, each time the user manually changes, using control elements, the parameterization or setting of the building technology setting, this change can be saved in such a way that the current ambient condition state and the manual parameterization are stored as a pair in the database 40. The machine learning model 22 thus replaces the predefined parameterization rules 21 after some time. Because the predefined parameterization rules 21 may only be rules that are based, for example, on the preferences of an average population, these parameterization rules 21 may not adequately reflect the preferences of the specific user or users of the building technology system. However, the machine learning model 22 is able to represent these preferences with a relatively high degree of precision once there are enough stored ambient condition states in the database 40 to draw on.

The actual transition from a current parameterization 13 to a (new) parameterization 30 which has been determined by the method may be carried out by sending a command from the current parameterization 13 to the determined (new) parameterization 30. Preferably, the transition or the sending of the command only takes place if the determined (new) parameterization 30 deviates from the current parameterization 13 by a predefined parameterization threshold. By providing a parameterization threshold, it is ensured that minor deviations between the determined (new) parameterization 30 and the current parameterization 13 are ignored. This is particularly advantageous with regard to the energy requirements of the building technology system, as unnecessary changes are avoided. The parameterization threshold also increases user comfort, as the user is not disturbed by any noise, for example when a sun protection system is extended or retracted, if this is not necessary. For example, a parameterization threshold may be defined as a 5% deviation from a desired or optimal brightness in lux. If the actual brightness deviates by a maximum of 5% from the desired or optimal brightness in lux, this is ignored as a minor deviation and does not lead to a change in the parameterization.

The machine learning model used in the method is trained, in particular continuously, through a training method. The training method may, in particular, comprise supervised machine learning and/or reinforcement machine learning. In detail, the training method according to the example of FIG. 2 may be as follows:

In response to a manual parameterization of a building technology system or no parameterization for a predefined period of time, the method comprises storing an ambient condition state and an associated parameterization of the building technology system in a database 40. The method further comprises training the machine learning model 22 based on at least a portion of the ambient condition states and associated parameterizations in the database 40.

A manual parameterization of the building technology system in the present example corresponds to the operation of control elements of the building technology system by a user. No manual parameterization of the building technology system in the present example corresponds to the omission of an operation of the control elements of the building technology system.

Also, it may optionally be provided that omitting parameterization for a predefined period of time only leads to storage of an ambient condition state and an associated parameterization of the building technology system in a database 40 if, in addition, the room and/or the building is occupied by at least one user. The occupancy may be determined, for example, by a sensor device 11 which is configured as an occupancy sensor.

If a parameterization corresponds to the user's preferences, the user will refrain from changing the parameterization via the control elements 12 of the sun protection system. For training the machine learning model 22, for example, after a parameterization has been determined based on a predefined parameterization rule 21, the time during which the user does not make any changes using the control elements 12 (omitting manual parameterization or omitting operation of the control elements) may be recorded. If the user does not carry out a manual parametrization for a certain period of time, it may be concluded that the parameterization corresponds to the user's actual preferences as regards the current ambient condition state. The detected ambient condition state and the associated parameterization are stored in the database 40 as a stored ambient condition state and used as training data for the machine learning model 22.

In other words, when training the machine learning model, an operation of control elements of the building technology system by a user and/or an occupancy of the room and failure to operate the control elements for a predefined period of time is recorded and in particular the current ambient condition state (with associated parameterization) is stored in the database 40. Preferably, if another criterion is met, an ambient condition state (with associated parameterization) stored in the database 40 receives a higher or lower weighting than other ambient condition states (with associated parameterization) stored in the database 40. For example, the other criterion which leads to a higher weighting of a stored ambient condition state (with associated parameterization) may be a failure to operate the control elements for another longer period of time.

However, if the parameterization does not correspond to the user's preferences, the user will manually change the parameterization using the control elements 12 and, for example, further retract or extend the sun protection system. For training the machine learning model 22, after manual parameterization by the user, it may be concluded that the new parameterization 30 corresponds to the user's preferences as regards the current ambient condition state. The detected ambient condition state and the associated parameterization are stored in the database 40 as a stored ambient condition state and used as training data for the machine learning model 22. Alternatively or additionally, after manual parameterization by the user, the time during which the user subsequently does not make any changes via the control elements 12 may be recorded. If no further change is detected via the control elements 12 within a predefined period of time after manual parameterization, it may be concluded that the parameterization now corresponds to the user's preferences for the current ambient condition state. The detected ambient condition state and the associated parameterization are stored in the database 40 as a stored ambient condition state and used as training data for the machine learning model 22.

The weighting may, in particular in the context of reinforcement machine learning, be carried out analogously to the principle of “reward and penalty”. Rewards may lead to a higher weighting of stored ambient condition states, whereas penalties may lead to a lower weighting of stored ambient condition states. In particular, it may be that only a higher weighting (reward) or only a lower weighting (penalty) is provided for. A reward and thus a higher weighting of an ambient condition state may be triggered, in particular, with an increase in time during which a user does not operate the control elements. The reward or higher weighting may, for example, increase continuously with the length of time the control elements are not operated. A penalty or lower weighting of ambient condition states may be triggered, in particular, if a user operates the control elements. The more often a user performs an operation, the higher the penalty or the lower the weighting may be, due to the operation.

Reinforcement machine learning preferably includes criteria that link certain actions of a user, in particular operations of control elements, with a reward or higher weighting or with a penalty or lower weighting of an ambient condition state. In particular, the criteria can be further developed within the framework of a separate “criteria learning model” in order to optimize the conditions for and the level of changes in weightings. This makes it possible to take into account dead times that occur, for example, during heating and cooling. A dead time may occur, in particular, due to a difference between a perceived temperature and an actual temperature and may, for example, be the time that elapses until the perceived and actual temperatures merge.

Furthermore, a memory cleanup may be provided, wherein it is checked whether the number of stored ambient condition states exceeds a predetermined maximum number. The maximum number may, in particular, be a maximum permitted number of stored ambient condition states. In particular, the cell-lists algorithm may be used for memory cleanup. In this case, the maximum number may be specified per cell in the cell-lists algorithm, for example as 100 ambient condition states per cell. If the number of stored ambient condition states exceeds the maximum number, or the maximum number within a cell of the cell-lists algorithm, the oldest stored ambient condition states may be deleted until the number of stored ambient condition states no longer exceeds the maximum number. The provision of memory management comes with the advantages already described above. Memory management can be understood as a part of monitoring, in the sense of supervised machine learning.

Furthermore, the machine learning model 22 may be trained by means of supervised and/or reinforcement machine learning. When training the machine learning model 22, training/test and/or cross validation splitting of the ambient condition states (and associated parameterizations) may be made use of (see above explanations).

The proposed functionality becomes clearer when considering the service life of a building technology system, starting with the initial installation. At the beginning, there are no stored ambient condition states (and associated parameterizations), but only predefined parameterization rules 21, which may, for example, be provided by the manufacturer of the building technology system and may be oriented towards a hypothetical average user. During operation, ambient condition states are recorded continuously or at discrete intervals by a sensor device 11 and the predefined parameterization rules 21 are drawn upon. This may be regarded as a first phase of the service life of the building technology system. After some time, the user, who is, for example, a resident of the building in which the building technology system is used, has made manual settings using control elements or, if the parameterizations based on the predefined parameterization rules 21 match with his/her preferences, has omitted the manual setting. By making manual settings and omitting manual settings, for example for a specified period of time, stored ambient condition states (and associated parameter parameterizations) are stored in the database 40. If ambient condition states are detected frequently, they can be assessed based on the machine learning model 22. In the case of rarely occurring detected ambient condition states, recourse remains to the predefined parameterization rules 21. In this phase, which can be regarded as the second phase of the service life of the building technology system, both the machine learning model 22 and the predefined parameterization rules 21 are required and used. After some time has passed and the machine learning model 22 can access a sufficient number of stored ambient condition states (and associated parameterizations), the machine learning model 22 is used primarily; ideally only the machine learning model 22 is used. This may be regarded as the third phase of the service life of the building technology system. Should the user change, for example due to a change of the tenant of a building, the machine learning model 22 is able to gradually adapt to the new preferences in the manner described above. Preferably, a reset function of the database 40 of stored ambient condition states (and associated parameterizations) may be provided.

The methods of reinforcement machine learning described above may be used for sun protection and lighting systems or for sun protection and lighting control, as in the case of time-period-dependent weighting of stored ambient condition states.

A particular application of the method according to the invention can also be in the control of air conditioning and heating systems, which may be part of a building technology system. Air conditioning and heating systems are usually controlled based on rules. Often it is only possible to change the temperature setpoint using the corresponding control elements 12. The challenge when controlling cooling is that, depending on the spatial conditions, the cooling can create a draft that is noticeable to the user. Due to this so-called wind chill, the perceived temperature deviates downwards from the measured temperature. This effect may cause affected users to increase the temperature setpoint. In the absence of an off switch to control the cooling, some users also try to stop it by opening the window (and thus activating the window contact). This leads to an increase in energy consumption, because after the window is closed the temperature has usually risen and the room is cooled more. The optimal control of cooling is usually different for each user and, if applicable, for each room and, in addition to achieving the desired temperature setpoint, also includes minimizing the burden on users due to cooling-related drafts. The use of the method according to the invention, in particular for cooling systems, makes it possible to take into account the preferences of a user without requiring the user to specify a specific temperature setpoint. This is particularly advantageous, especially since a user can usually only express his/her subjective temperature perception imprecisely in the form of a temperature setpoint. The method may further take into account a dead time within which a perceived temperature deviates from an actual temperature. As part of the sensor device 11, a touch sensor may also be provided on a window, which registers and takes into account a window contact of the user.

Although some aspects have been described with regard to an apparatus, it is clear that these aspects also represent a description of the corresponding method, wherein a block or an apparatus corresponds to a method step or a function of a method step. Analogously, aspects described with regard to a method step also represent a description of a corresponding block or element or a property of a corresponding apparatus.

Examples of the invention may be implemented in a computer system. The computer system may be a local computing device (e.g., personal computer, laptop, tablet computer, or mobile phone) having one or more processors and one or more storage devices, or may be a distributed computing system (e.g., a cloud computing system having one or more processors or one or more storage devices distributed across different locations, for example, a local client and/or one or more remote server farms and/or data centers). The computer system may include any circuit or combination of circuits. In an example, the computer system may include one or more processors, which may be of any type. As used herein, “processor” may mean any type of computing circuit, such as, but not limited to, a microprocessor, a microcontroller, a complex instruction set microprocessor (CISC), a reduced instruction set microprocessor (RISC), a very long instruction word (VLIW) microprocessor, a graphics processor, a digital signal processor (DSP), a multi-core processor, a field-programmable gate array (FPGA), or any other type of processor or processing circuit. Other types of circuitry that may be included in the computer system may be a custom-built circuit, an application specific integrated circuit (ASIC), or the like, such as one or more circuits (e.g., a communications circuit) for use with wireless devices such as cellular phones, tablet computers, laptop computers, two-way radios, and similar electronic systems. The computer system may include one or more storage devices, which may include one or more storage elements suitable for the particular application, such as a main memory in the form of a random access memory (RAM), one or more hard disks, and/or one or more drives containing removable media, such as CDs, flash memory cards, DVDs and the like. The computer system may also include a display device, one or more speakers, and a keyboard and/or controller, which may include a mouse, trackball, touch screen, voice recognition device, or any other device that allows a system user to enter information into and receive information from the computer system.

Some or all of the method steps may be carried out by (or using) a hardware device, such as a processor, a microprocessor, a programmable computer, or an electronic circuit. In examples, one or more of the key method steps may be carried out by such a device.

Depending on particular implementation requirements, examples of the invention may be implemented in hardware or software. The implementation may be carried out with a non-volatile storage medium such as a digital storage medium such as a floppy disk, a DVD, a Blu-Ray, a CD, a ROM, a PROM and EPROM, an EEPROM or a FLASH memory on which electronically readable control signals are stored that interact (or may interact) with a programmable computer system to carry out the respective method. Therefore, the digital storage medium may be computer-readable.

Further, a data carrier can be provided with electronically readable control signals that may interact with a programmable computer system such that one of the methods described herein is carried out.

In general, examples of the present invention may be implemented as a computer program product having a program code, wherein the program code is effective for carrying out one of the methods when the computer program product is running on a computer. The program code may, for example, be stored on a machine-readable medium.

Further examples can also include the computer program for carrying out one of the methods described herein, which is stored on a machine-readable data carrier.

In other words, an example of the present invention can be a computer program with a program code for carrying out one of the methods described herein when the computer program runs on a computer.

A further example includes a storage medium (or a data carrier or a computer-readable medium) comprising a computer program stored thereon for carrying out any of the methods described herein when executed by a processor. The data carrier, the digital storage medium or the recorded medium are usually tangible and/or not seamless. A further example of the present invention can include an apparatus as described herein comprising a processor and the storage medium.

A further example of the invention can include a data stream or a signal sequence representing the computer program for carrying out one of the methods described herein. For example, the data stream or signal sequence may be configured to be transmitted over a data communication connection, for example over the Internet.

A further example can include a processor, for example a computer or a programmable logic device, configured or adapted to perform any of the methods described herein.

A further example can comprise a computer on which the computer program for carrying out one of the methods described herein is installed.

A further example of the invention can comprise a device or system configured to transmit (e.g., electronically or optically) a computer program for carrying out one of the methods described herein, to a receiver. The receiver may be, for example, a computer, a mobile device, a storage device or the like. The device or system may, for example, comprise a file server for transmitting the computer program to the receiver.

In some examples, a programmable logic device (e.g., a field programmable gate array, FPGA) may be used to perform some or all of the functionality of the methods described herein. In examples, a field programmable gate array may cooperate with a microprocessor to perform any of the methods described herein. In general, the methods are preferably carried out by each hardware device.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A computer-implemented method for determining a parameterization of a building technology system, the method comprising:
receiving an ambient condition state detected by at least one sensor device;
determining a number of ambient condition states stored in a database that satisfy a similarity criterion with respect to the detected ambient condition state; and
determining:
if the number is smaller than a predetermined threshold, the parameterization of the building technology system based on at least one predefined parameterization rule; or
if the number is greater than or equal to the threshold, the parameterization of the building technology system based on a machine learning model.

2. The method of claim 1, further comprising:
sending a command to change a present parameterization of the building technology system to the determined parameterization,
wherein, the sending only takes place if the determined parameterization deviates from the present parameterization by a predefined parameterization threshold value.

3. The method of claim 1, wherein predefined restrictions or safety restrictions are observed in determining the parameterization.

4. The method of claim 1, further comprising:
receiving presence information and/or identification information,
wherein the presence information contains at least information about the number of people in a room which is covered by the building technology system,
wherein the identification information contains at least information that enables a clear identification of people in the room or people entering the room, and
wherein the presence information and/or the identification information are taken into account for determining the parameterization.

5. The method of claim 4, wherein the at least one predefined parameterization rule and/or the machine learning model for determining the parameterization are selected from a plurality of parameterization rules and a plurality of machine learning models, respectively, depending on the presence information and/or depending on the identification information.

6. The method of claim 1, wherein the ambient condition state detected by the sensor device comprises at least one of the following pieces of information:
a measured value of a light sensor;
a measured value of a wind sensor;
a measured value of a temperature sensor;
a difference between a temperature and a perceived temperature;
a measured value of a room occupancy sensor;
a time;
a measured value of a touch sensor or a measured value of a touch sensor on on a window handle;
a date or a date without the year;
a status of a building element or a status of a window;
a status of an air conditioning system;
a status of a heating system;
a status of a sun protection system; and/or
a status of a lighting system, and/or
wherein the parameterization of the building technology system comprises a parameterization of at least one of the following:
a building element or a window;
an air conditioning system;
a heating system;
a sun protection system; and/or
a lighting system.

7. The method of claim 1, wherein the similarity criterion for stored ambient condition states is evaluated according to the cell-lists algorithm, wherein the similarity criterion for a stored ambient condition state is preferably met if the difference between the detected ambient condition state and the stored ambient condition state does not exceed a value.

8. A computer-implemented method for training a machine learning model for the method according to claim 1, the method comprising:
saving, in response to a manual parameterization of a building technology system or non-parametrization persisting for a predefined period of time, an ambient condition state and an associated parameterization of the building technology system in a database; and
training the machine learning model via at least a subset of the ambient condition states and associated parameterizations in the database.

9. A device or a control unit of a building technology system to carry out the method of claim 1.

10. A computer program comprising instructions which, when the program is executed by a computer, causes the computer to carry out the method of claim 1.
